(19) United States
(12) Patent Application Publication
(10) Pub. No.: US 2024/0055928 A1
(43) Pub. Date: Feb. 15, 2024

(54) MOTOR

(71) Applicant: MINEBEA MITSUMI Inc., Kitasaku-gun, Nagano (JP)

(72) Inventor: Jun OHMURA, Kitasaku-gun, Nagano (JP)

(21) Appl. No.: 18/259,138

(22) PCT Filed: Dec. 16, 2021
(86) PCT No.: PCT/JP2021/046461

§ 371 Date: Jun. 23, 2023

(30) Foreign Application Priority Data
Jan. 20, 2021 (JP) 2021-007349

(51) Int. Cl. H02K 5/15; H02K 1/27915; H02K 5/173

(52) U.S. Cl. CPC H02K 5/15; H02K 1/27915; H02K 5/1737

(57) ABSTRACT

To achieve miniaturization in the rotation axis direction. A motor includes a stator housing having an inner peripheral portion and an outer peripheral portion, a stator supported by an outer peripheral portion of the stator housing, a rotor housing covering the stator housing and the stator, and a magnet supported by an outer peripheral portion of the rotor housing. The stator includes a first surface provided at an inner side of the magnet, supported by the stator housing and positioned in a rotation axis direction, and a second surface opposing an outside in the rotation axis direction. A surface of the magnet supported by the rotor housing is provided at an upper surface portion side of the stator core in the rotation axis direction.

### TECHNICAL FIELD

The present invention relates to a motor.

### BACKGROUND ART

As an outer rotor type motor, there is known a brushless motor having a rotor where a drive magnet and a position detection magnet are fixed inside a rotor case along an axial direction (for example, see Patent Document 1). In the brushless motor, between the drive magnet and the position detection magnet, an annular isolation plate having a positioning portion for positioning the drive magnet and the position detection magnet in a peripheral direction is disposed.

### CITATION LIST

### Patent Literature

Patent Document 1: JP 2018-117429 A

### SUMMARY OF INVENTION

### Technical Problem

In general, in an outer rotor type motor, a rotor housing is disposed to oppose a stator housing in a radial direction. In a conventional outer rotor type motor, positioning directions of a stator core and a magnet in a rotation axis direction are configured to face each other in the respective rotation axis directions. For this reason, in the conventional outer rotor type motor, it is necessary to secure a large gap between the stator core and the rotor housing in the rotation axis direction in consideration of, for example, an influence of variation or the like at the time of manufacturing. That is, in the conventional outer rotor type motor, the rotor housing is increased in size in consideration of the change in thickness of the stator core.

In addition, in a motor, a magnetic path width is generally changed in order to change a torque constant for defining a characteristic of the motor. In this case, in order to change the magnetic path width of the motor, the length of the stator core in a stacking direction (rotation axis direction) is changed.

However, when the length of the stator core in the stacking direction is changed in the conventional motor, for example, there is a problem where the centers of the magnet and the stator core in the rotation axis direction are deviated from each other when the length of the stator core in the stacking direction is increased. Therefore, in the conventional motor, in order to align the positions of the centers in the rotation axis direction, it is necessary to design the motor in accordance with the thickness of each of the rotor housing and the stator housing.

An object of the present invention is to provide a motor configured to be miniaturized in the rotation axis direction.

### Solution to Problem

A motor according to the present invention includes: a stator housing including an inner peripheral portion and an outer peripheral portion; a stator supported by the outer peripheral portion of the stator housing; a rotor housing covering the stator housing and the stator; and a magnet supported by an outer peripheral portion of the rotor housing, wherein the stator includes a first surface provided at an inner side of the magnet, supported by the stator housing and positioned in a rotation axis direction, and a second surface opposing an outside in the rotation axis direction, and a surface of the magnet supported by the rotor housing is provided at a side of the first surface of the stator in the rotation axis direction.

In a motor according to an aspect of the present invention, a gap is formed between the first surface of the stator and the rotor housing in the rotation axis direction.

In a motor according to an aspect of the present invention, the stator housing includes a positioning portion configured to position the first surface of the stator in the rotation axis direction.

In a motor according to an aspect of the present invention, the rotor housing includes a positioning portion configured to position a surface of the magnet supported by the rotor housing in the rotation axis direction.

In a motor according to an aspect of the present invention, the rotor housing includes a second positioning portion protruding from the positioning portion in the rotation axis direction.

According to the motor of the present invention, miniaturization in the rotation axis direction can be achieved.

### BRIEF DESCRIPTION OF DRAWINGS

FIG. 1 is a perspective view roughly illustrating a configuration of a motor according to the embodiment of the present invention.

FIG. 2 is a plan view of the motor illustrated in FIG. 1.

FIG. 3 is a side cross-sectional view of the motor illustrated in FIG. 1.

### DESCRIPTION OF EMBODIMENTS

A motor according to the embodiment of the present invention will be described below with reference to the drawings.

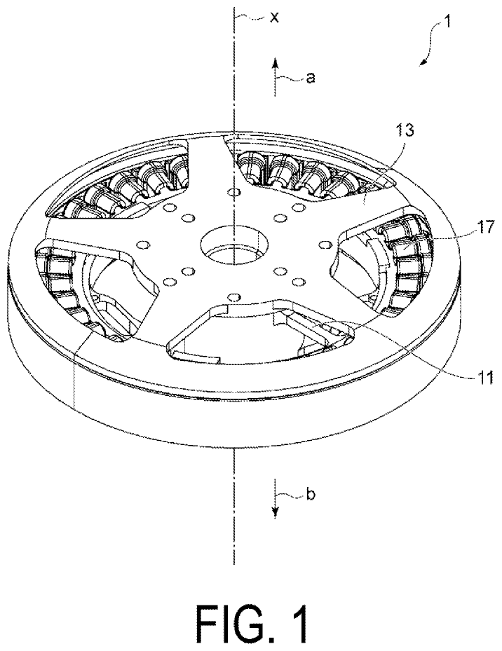

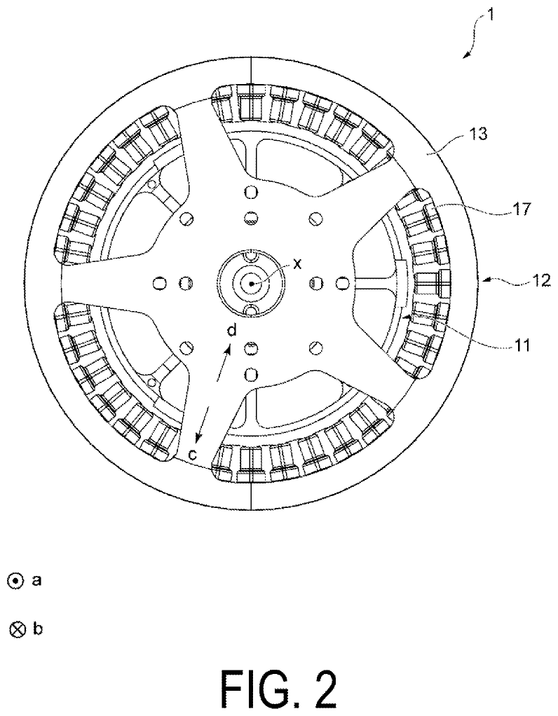

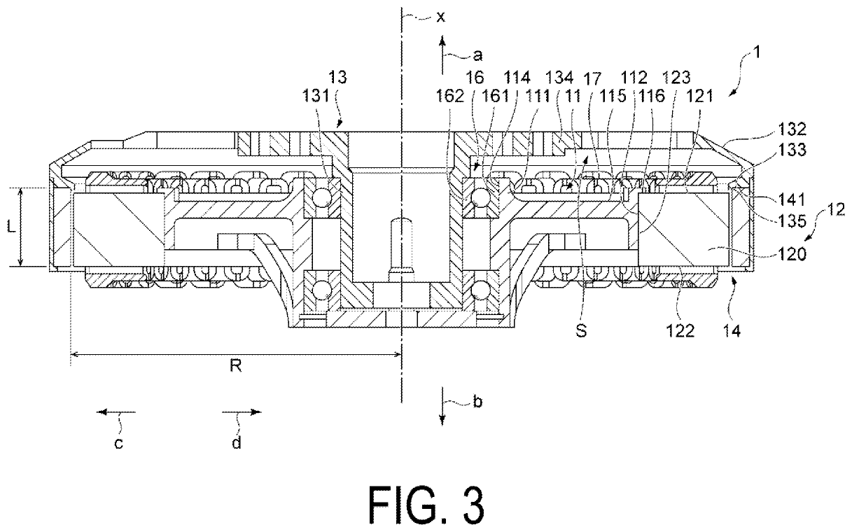

FIG. 1 is a cross-sectional view schematically illustrating a configuration of a motor 1 according to the embodiment of the present invention. FIG. 2 is a plan view of the motor 1. FIG. 3 is a side cross-sectional view of the motor 1.

For the sake of convenience, an extending direction of a rotation axis line x when the motor 1 rotates is defined as an axis line x direction in the following description. The axis line x direction is also referred to as a rotation axis direction. In the following description, in the axis line x direction, for the sake of convenience, an arrow a direction is referred to as an upper side a, and an arrow b direction is referred to as a lower side b. Further, in a radial direction perpendicular to the axis line x, a direction away from the axis line x (arrow c direction in FIGS. 2 and 3) is referred to as an outer peripheral side c, and a direction toward the axis line x (arrow d direction in FIGS. 2 and 3) is referred to as an inner peripheral side d. In the following description, the direction illustrated in FIG. 3 is referred to as a side surface of the motor 1 for the sake of convenience. Further, in the following description, for the sake of convenience, a direction where the motor 1 is viewed from the upper side a toward the lower side b is referred to as a plan view, and a direction where the motor 1 is viewed from the lower side b toward the upper side a is referred to as a bottom view.

As illustrated in FIG. 3, the motor 1 according to the present embodiment includes a stator housing 11 including an inner peripheral portion 111 and an outer peripheral portion 112, a stator 12 supported by the outer peripheral portion 112 of the stator housing 11 and including a stator core 120 and a coil 17, a rotor housing 13 covering the stator housing 11 and the stator 12, and a magnet 14 supported by an outer peripheral portion 132 of the rotor housing 13. The stator 12 is provided inside the magnet 14, and includes an upper surface portion 121 of the stator core 120 serving as a first surface supported by the stator housing 11 and positioned in the rotation axis direction, and a lower surface portion 122 serving as a second surface opposing the outside in the rotation axis direction. In the magnet 14, an upper surface portion 141 serving as a surface supported by the rotor housing 13 is provided at a side of the upper surface portion 121 of the stator core 120 in the rotation axis direction. Hereinafter, configurations and operations of the motor 1 will be described with details.

### Configuration of Motor

As described above, the motor 1 includes the stator housing 11, the stator 12, the rotor housing 13, the magnet 14, and a bearing 16 as main components.

The stator housing 11 includes a bearing holder 114 and a coupling portion 115 in addition to the inner peripheral portion 111 and the outer peripheral portion 112 described above. As illustrated in FIG. 2, in the stator housing 11, the inner peripheral portion 111 and the outer peripheral portion 112 described above are formed in an annular shape about the axis line x.

As illustrated in FIG. 3, the inner peripheral portion 111 is formed in a cylindrical shape or substantially cylindrical shape extending in the axis line x direction. The inner peripheral portion 111 includes the bearing holder 114 holding the bearing 16 at a surface at the inner peripheral side d. For example, two bearing holders 114 are provided in accordance with the number of bearings 16. The bearing holder 114 holds a surface at the outer peripheral side c of an outer ring 161 of the bearing 16.

The outer peripheral portion 112 is formed in an annular shape or a substantially annular shape about the axis line x direction. The coupling portion 115 is connected to the outer peripheral portion 112 at the inner peripheral side d. An inner peripheral surface portion 123 of the stator core 120 of the stator 12 at the inner peripheral side d faces a surface of the outer peripheral portion 112 at the outer peripheral side c. The outer peripheral portion 112 includes a positioning portion 116 configured to position the upper surface portion 121 as the first surface of the stator core 120 of the stator 12 in the axis line x direction.

The positioning portion 116 is provided at an end portion at the upper side a of the outer peripheral portion 112 of the stator housing 11 in the axis line x direction. In addition, the positioning portion 116 protrudes from a surface of the outer peripheral portion 112 at the outer peripheral side c toward the outer peripheral side c in the radial direction. The positioning portion 116 is in contact with the upper surface portion 121 of the stator core 120 to position the stator core 120 in the axis line x direction.

The coupling portion 115 couples the inner peripheral portion 111 and the outer peripheral portion 112. For example, the coupling portion 115 extends in the radial direction from the inner peripheral portion 111 toward the outer peripheral portion 112.

The stator core 120 is a stacked body of magnetic bodies such as silicon steel plates. The stator core 120 includes an annular portion and a teeth portion serving as a plurality of magnetic pole units formed to extend from the annular portion toward the outer peripheral side c. The stator 12 is fixed to the stator housing 11 by the inner peripheral surface portion 123 being fixed to a surface at the outer peripheral side c of the outer peripheral portion 112 of the stator housing 11.

An insulator (not illustrated) serving as an insulating member is mounted at the teeth portion of the stator core 120. The coil 17 is wound around an insulator mounted around each of the plurality of teeth portions. The stator core 120 and the coil 17 are insulated by the insulator. Note that the insulating member is not limited to the insulator as long as the stator core 120 and the coil 17 are insulated from each other. For example, a structure such as insulating coating, insulating paper, or an insulation sheet may be used.

The magnet 14 is attached to the rotor housing 13. The rotor housing 13 has a substantially annular shape as a whole. As illustrated in FIG. 2, an inner peripheral portion 131 and an outer peripheral portion 132 of the rotor housing 13 are formed in an annular shape about the axis line x.

As illustrated in FIG. 3, the inner peripheral portion 131 is formed in a cylindrical shape or substantially cylindrical shape extending in the axis line x direction. A surface of the inner peripheral portion 131 at the outer peripheral side c is held by a surface of an inner ring 162 of the bearing 16 at the inner peripheral side d. That is, the inner peripheral portion 131 functions as a rotation axis in the motor 1.

The outer peripheral portion 132 is formed in an annular shape or a substantially annular shape about the axis line x direction. An coupling portion 134 is connected to the inner peripheral side d of the outer peripheral portion 132. A surface of the outer peripheral portion 132 at the inner peripheral side d faces a surface of the magnet 14 at the outer peripheral side c.

In a cross section of the rotor housing 13 perpendicular to the axial direction (axis line x direction), the cross section of the magnet 14 appears as a rectangle (see FIG. 3). The rotor housing 13 includes a positioning portion 133 configured to position the upper surface portion 141 as a surface of the magnet 14 supported by the rotor housing 13 in the axis line x direction and as a surface at the upper side a.

The positioning portion 133 is provided at the upper side a of the outer peripheral portion 132 of the rotor housing 13 in the axis line x direction. In addition, the positioning portion 133 protrudes from a surface of the outer peripheral portion 132 at the inner peripheral side d toward the inner peripheral side d in the radial direction. The positioning portion 133 is in contact with the upper surface portion 141 of the magnet 14 to position the magnet 14 in the axis line x direction.

The outer peripheral portion 132 of the rotor housing 13 is provided with a second positioning portion 135 in order to position the magnet 14 at the inner peripheral side d. The second positioning portion 135 protrudes from an end portion of the positioning portion 133 at the inner peripheral side d toward the lower side b. By positioning the magnet 14 in the radial direction by the second positioning portion 135, the magnet 14 can be attached with the minimum tolerance accumulation without being affected by the dimensional tolerance of the magnet 14, the coaxiality of the inner and outer diameters, the fitting gap with other members, and the like. Therefore, an air gap between the stator 12 and the magnet 14 can be designed to be narrow. Therefore, the motor output can be improved. Note that, since the second positioning portion 135 can be machined with high accuracy by simultaneous lathe machining with the inner peripheral portion 131 serving as the rotation center, the motor output of manufacturing and machining can easily be improved.

The coupling portion 134 couples the inner peripheral portion 131 and the outer peripheral portion 132. For example, the coupling portion 134 extends in the radial direction from the inner peripheral portion 131 toward the outer peripheral portion 132. A gap S is formed in the axis line x direction between the upper surface portion 121 of the stator 12 and the surface at the lower side b of the coupling portion 134 of the rotor housing 13.

### Operation of Motor

Next, an operation of the motor 1 having the above-described configuration will be described.

A torque constant (Kt) for defining the characteristics of the motor is expressed by the following formula (1). In the formula (1), R is the rotation radius of the motor, N is the number of coil turns, b is the magnetic flux density, and L is the magnetic path width (length of the magnet in the axis line x direction).

Kt=2×R×N×b×L (1)

In the motor 1, when the torque constant is changed by adjusting the numerical value of the above-described formula (1), the magnetic path width (L) of the motor 1 is generally changed. In order to change the magnetic path width, in the motor 1, the length of the stator core 120 in the stacking direction (the axis line x direction), specifically, the thickness of the stator core 120 is changed.

For example, when the motor 1 is used as an outer rotor motor for a drone, a propeller (not illustrated) is attached to a surface at a top surface side (upper side a) of the stator 12, and a surface at a bottom surface side (lower side b) of the rotor housing 13 opposing the surface at the top surface side is attached to an aircraft body (not illustrated).

When assembling the motor 1, the stator 12 and the magnet 14 are assembled to the stator housing 11 and the rotor housing 13, respectively, from the axis line x direction. Therefore, in the motor 1, the stator housing 11 needs to have a portion (positioning portion) for positioning the stator 12 in the axis line x direction. Similarly, in the motor 1, the rotor housing 13 requires a positioning portion for positioning the magnet 14 in the axis line x direction.

There may be a case where the positioning surfaces of the stator core 120 and the magnet 14 face each other in the axis line x direction. Specifically, for example, the positioning portion of the stator housing 11 is considered to be provided at the lower side b in the axis line x direction, and the positioning portion of the rotor housing 13 is considered to be provided at the upper side a in the axis line x direction. In such a case, if an attempt is made to change the thickness of the stator core 120, the centers of the magnet 14 and the stator core 120 in the axis line x direction are displaced from each other.

On the other hand, as described above, in the motor 1, the positioning portion 116 configured to position the stator core 120 of the stator 12 in the axis line x direction and the positioning portion 133 configured to position the magnet 14 in the axis line x direction both face the lower side b. That is, the positioning direction of the stator core 120 in the axis line x direction and the positioning direction of the magnet 14 in the axis line x direction coincide with each other.

According to the motor 1 configured as described above, when the thickness of the stator core 120 is changed, for example, even if the thickness of the stator core 120 is changed, the centers of the magnet 14 and the stator core 120 in the axis line x direction can be prevented from being displaced. That is, according to the motor 1, the center positions of the stator core 120 and the magnet 14 in the axis line x direction can easily be aligned.

In addition, since the positioning portion 116 and the positioning portion 133 are both provided at the upper side a in axis line x direction, according to the motor 1, the gap S as a gap between the stator core 120 and the rotor housing 13 can be prevented from being narrowed even when there is a variation in the stacking thickness of the stator core 120. That is, according to the motor 1, the gap S in design can be designed to be narrow, and thus the configuration can be miniaturized.

Therefore, according to the motor 1 where both the positioning portion 116 and the positioning portion 133 are provided at the upper side a in the axis line x direction, miniaturization in the rotation axis direction can be achieved.

In addition, the motor 1 may be appropriately modified by a person skilled in the art according to conventionally known knowledge. Such modifications are of course included in the scope of the present invention as long as these modifications still include the configuration of the present invention.

### REFERENCE SIGNS LIST

1 Motor 11 Stator housing 12 Stator 13 Rotor housing 14 Magnet 16 Bearing 17 Coil 111 Inner peripheral portion 112 Outer peripheral portion 114 Bearing holder 115 Coupling portion 116 Positioning portion 120 Stator core 121 Upper surface portion 122 Lower surface portion 123 Inner peripheral surface portion 131 Inner peripheral portion 132 Outer peripheral portion 133 Positioning portion 134 Coupling portion 135 Second positioning portion 141 Upper surface portion 161 Outer ring 162 Inner ring

1. A motor comprising:
a stator housing including an inner peripheral portion and an outer peripheral portion;
a stator supported by the outer peripheral portion of the stator housing;
a rotor housing covering the stator housing and the stator; and
a magnet supported by an outer peripheral portion of the rotor housing, wherein
the stator includes
a first surface provided at an inner side of the magnet, supported by the stator housing and positioned in a rotation axis direction, and
a second surface opposing an outside in the rotation axis direction, and
a surface of the magnet supported by the rotor housing is provided at a side of the first surface of the stator in the rotation axis direction.

2. The motor according to claim 1, wherein
a gap is formed between the first surface of the stator and the rotor housing in the rotation axis direction.

3. The motor according to claim 1, wherein
the stator housing includes a positioning portion configured to position the first surface of the stator in a rotation axis direction.

4. The motor according to claim 1, wherein
the rotor housing includes a positioning portion configured to position the surface of the magnet supported by the rotor housing in the rotation axis direction.

5. The motor according to claim 4, wherein
the rotor housing includes a second positioning portion protruding from the positioning portion in the rotation axis direction.
